(19) United States
(12) Patent Application Publication
(10) Pub. No.: US 2026/0346969 A1
(43) Pub. Date: Nov. 5, 2026

(54) METHOD AND SYSTEM FOR BINOCULAR VISUAL SERVOING OF UNDERWATER VEHICLE-DUAL-ARM MANIPULATOR AUTONOMOUS OPERATION

(71) Applicant: HUAZHONG UNIVERSITY OF SCIENCE AND TECHNOLOGY, Hubei (CN)

(72) Inventors: Xianbo Xiang, Hubei (CN); Chaicheng Jiang, Hubei (CN); Gong Xiang, Hubei (CN); Yang Qu, Hubei (CN); Shaolong Yang, Hubei (CN)

(73) Assignee: HUAZHONG UNIVERSITY OF SCIENCE AND TECHNOLOGY, Hubei (CN)

(21) Appl. No.: 19/417,395

(22) Filed: Dec. 12, 2025

(30) Foreign Application Priority Data
Apr. 30, 2025 (CN) 202510563148.4

(51) Int. Cl. B63G 8/38; B25J 9/16; B63G 8/00; G06V 10/26; G06V 10/62; G06V 10/77; G06V 10/80; G06V 20/05; G06V 20/58; G06V 20/64

(52) U.S. Cl. CPC B63G 8/38; B25J 9/1697; B63G 8/001; G06V 10/273; G06V 10/62; G06V 10/7715; G06V 10/803; G06V 20/05; G06V 20/58; G06V 20/647; B63G 2008/004; G06V 2201/07

(57) ABSTRACT

A method for binocular visual servoing of an underwater vehicle-dual-arm manipulator autonomous operation includes: acquiring a two-dimensional image and a depth image in front of an underwater vehicle-dual-arm manipulator; inputting the two-dimensional image into a lightweight target detector to obtain a target identification frame; designing a target three-dimensional coordinate observation value acquisition method based on a shape of the identification frame; solving an apparatus movement matrix based on three-dimensional coordinates of key points in images at adjacent moments; treating target three-dimensional coordinates as state vectors and designing a nonlinear Kalman filtering method based on the movement matrix to implement continuous estimation of a target position; driving the vehicle-manipulator to move with reference to the target three-dimensional coordinates and driving an end joint of the manipulator to move by using the two-dimensional image, so that after the manipulator reaches a target, an effector thereof may effectively grasp the target.

### CROSS-REFERENCE TO RELATED APPLICATION

This application claims the priority benefit of China application serial no. 202510563148.4, filed on Apr. 30, 2025. The entirety of the above-mentioned patent application is hereby incorporated by reference herein and made a part of this specification.

### BACKGROUND

### Technical Field

The disclosure belongs to the field of underwater operations, and more specifically, relates to a method for binocular visual servoing of an underwater vehicle-dual-arm manipulator autonomous operation.

### Description of Related Art

At present, with the growing demand for marine resource development, advanced underwater operation technologies become increasingly important. Underwater vehicle-manipulator systems have been widely applied in various marine operation scenarios, such as seabed mining, marine aquaculture, deep-sea oil and gas system operation and maintenance, and underwater rescue. As operation scenarios become increasingly complex, the requirements for environmental perception capabilities and operation autonomy of underwater vehicle-manipulator systems gradually grow as well.

However, in practical applications, various noise interferences in complex underwater environments affect the target detection based on visible light cameras and binocular stereo matching, bringing much challenges to continuous positioning of the targets. In addition, the posture of an underwater target has considerable randomness, and failure to adjust the grasping angle according to the target's posture will significantly affect the operation success rate. Therefore, in order to improve the autonomy and efficiency of operations, it is necessary to study advanced vision servo methods. For instance, industrial vision technology can be used to implement real-time monitoring and precise measurement of underwater environments, so as to provide accurate environmental information for the operations performed by the underwater vehicles and the manipulators. Meanwhile, industrial control software can be used to process and analyze these vision data, generate control commands, and implement precise control of underwater vehicle-arm manipulators, and the automation level and operation efficiency of underwater operations are thereby improved. This combination can not only improve the safety and reliability of underwater operations, but also expand the application fields of underwater operations, so as to satisfy the adaptability of underwater vehicle-manipulator systems to complex operation tasks.

### SUMMARY

In view of the defects of the related art, the disclosure aims to provide a method for binocular visual servoing of an underwater vehicle-dual-arm manipulator autonomous operation, so as to solve the problem that an underwater vehicle-dual-arm manipulator of the related art is unable to continuously position a target in complex underwater environments.

To achieve the above, in the first aspect, the disclosure provides a method for binocular visual servoing of an underwater vehicle-dual-arm manipulator autonomous operation, and an underwater vehicle and a dual-arm manipulator form an apparatus configured to perform an underwater operation. The method includes the following steps.

A two-dimensional image and a depth image of a target in front of an underwater vehicle-dual-arm manipulator are acquired, the two-dimensional image is inputted into a target detector to obtain a target identification frame, pixel points with invalid depth values in the search region are eliminated based on a search region of three-dimensional coordinate on the depth image, which is determined by the target identification frame, and in combination with the depth image, the pixel points with median depth values are retained based on a sorting of depth values, thereby determining a three-dimensional coordinate observation value of the target.

Three-dimensional coordinates of a plurality of key points on the two-dimensional image are determined with reference to the depth image, and movement parameters of the apparatus are acquired by combining the three-dimensional coordinates of the key points at two consecutive moments.

Three-dimensional coordinates and a three-dimensional velocity of the target are treated as state vectors, the three-dimensional coordinate observation value of the target is treated as an observation vector, a three-dimensional coordinate prediction value of the target is acquired by combining the movement parameters, the three-dimensional coordinate observation value and the three-dimensional coordinate prediction value are fused based on a Kalman filtering method, and a three-dimensional coordinate unbiased estimation value of the target is obtained.

The apparatus is driven to move to a predetermined position with reference to the three-dimensional coordinate unbiased estimation value of the target, an effector of at least one manipulator is controlled to move toward the target according to the three-dimensional coordinate unbiased estimation value of the target, and an end joint of a corresponding effector is driven to rotate by using the two-dimensional image of the target, so that after the at least one manipulator reaches the target, the effector thereof effectively clamps the target.

It should be noted that in some application scenarios, the above target detector may also acquire target categories, and furthermore, it may be subsequently determined according to the target categories whether to control effectors of one manipulator or two manipulators to move toward the target. This disclosure does not make special limitations on this, and a person having ordinary skill in the art may design according to needs.

Exemplarily, the above depth image is acquired through a binocular camera after stereo matching.

It can be understood that in the disclosure, the two-dimensional image is inputted into a lightweight target detector to obtain a target identification frame. A target three-dimensional coordinate observation value acquisition method is designed based on a shape of the identification frame to reduce the influence of disparity voids. An apparatus movement matrix is solved based on three-dimensional coordinates of key points in images at adjacent moments. Target three-dimensional coordinates are treated as state vectors, and a nonlinear Kalman filtering method is designed based on the movement matrix to implement unbiased estimation of a target position.

Specifically, after the target frame is acquired in the disclosure, a three-dimensional coordinate observation value of the target is acquired in combination with the depth image acquired through binocular vision. Compared with the related art that directly selects three-dimensional coordinates at a center point of the target frame after the target frame is acquired, in the disclosure, invalid values and outliers therefrom are eliminated in combination with depth information of pixels around the center of the target frame, and the three-dimensional coordinates of the target are jointly calculated, making the calculated coordinate values more accurate. In addition, the Kalman filtering method combined with hull movement estimation makes target positioning more continuous. This effectively solves problems of discontinuous and non-smooth target positioning caused by disparity holes, detector missed detections, hull oscillation, etc. Moreover, in the disclosure, when the manipulator is controlled, an angle of the end joint of the manipulator is adjusted in combination with the target image. Compared with the related art that does not consider the posture relationship between the manipulator end joint and the target, this can greatly improve the probability of effectively grasping the target and ensure the success rate of underwater operations. Further, in the disclosure, a target type may be acquired according to the target detector, single manipulator or dual manipulator operations are then controlled in combination with the target type, and high flexibility is thus provided.

The visual servo method designed by this disclosure may enable underwater vehicle and the manipulator to complete various autonomous operation tasks and has adaptability to the randomness of target postures. Meanwhile, it may be extended to dual-arm operation tasks, so that operation efficiency and success rate may be effectively improved.

In an embodiment, the target detector includes: a feature extractor, an encoder, and a decoder.

The feature extractor is configured to extract features of the target in the two-dimensional image.

The encoder is configured to adjust features extracted by the feature extractor to a same scale and splice the features in a channel dimension to acquire a feature F, perform dimensionality reduction on the feature F through convolution to acquire a feature F′, convert the feature F′ to a frequency domain using fast Fourier transform corresponding to a frequency spectrum f′, adjust information in the frequency spectrum f′ through a learnable filter, then convert it back to a time domain using inverse fast Fourier transform to acquire new features, sequentially input the new features to a first multilayer perceptron, a deformable convolution network, and a second multilayer perceptron for processing to acquire encoder-enhanced features.

The decoder is configured to acquire the target identification frame through depth-separable convolution.

In an embodiment, the determining the three-dimensional coordinate observation value of the target includes the following steps.

A center point within the target identification frame is treated as a center of the search region on the depth image, and a width and a height of the search region are determined according to a size of the target identification frame.

The depth image is matched with the two-dimensional image according to pixel coordinates, and the depth value of each pixel point within the search region is acquired.

All pixel points within the search region are sorted according to the depth values.

The invalid pixel points in the search region are eliminated based on a predetermined sorting threshold, and a new pixel point set is acquired.

The middle pixel points by order in the new pixel point set are kept.

Three-dimensional coordinates of all retained pixel points are averaged, and the three-dimensional coordinate observation value of the target is obtained.

In an embodiment, the retaining the pixel points with the median depth values in the new pixel point set includes the following steps.

An upper quartile Q₁ and a lower quartile Q₂ of the sorting in the new pixel point set are calculated:

$${Q}_{1} = \frac{n + 1}{4} and {Q}_{2} = \frac{3 ( n + 1 )}{4} ,$$

where, n is the total number of pixel points included in the new pixel point set.

Depth values at positions corresponding to Q₁ and Q₂ are treated as thresholds ε₁ and ε₂ if Q₁ and Q₂ are integers.

Rounding up and rounding down are performed if Q₁ and Q₂ are not integers, Q^{up}₁, Q^{down}₁, Q^{up}₂, and Q^{down}₂, are obtained, and four depth values ε^{up}₁, ε^{down}₁, ε^{up}₂, ε^{down}₂ at corresponding positions are obtained, ε₁=0.25×ε^{up}₁+0.75×ε^{down}₁ and ε₂=0.75×ε^{up}₂+0.25×ε^{down}₂.

Pixel points are retained when a depth value pᵢ satisfies ε₁<pᵢ<ε₂.

In an embodiment, the acquiring the movement parameters of the apparatus by combining the three-dimensional coordinates of the key points at two consecutive moments includes the following steps.

An error function eᵢ of an i^{th} key point is set as:

eᵢ=pᵢ−(Rp′ᵢ+T),
where pᵢ represents three-dimensional coordinates of the i^{th} key point at a current moment, p′ᵢ represents three-dimensional coordinates of the i^{th} key point at a previous moment, R represents a three-dimensional movement rotation matrix of the apparatus, and T represents a translation vector of the apparatus. R and T constitute the movement parameters.

The R and T are solved with an objective of minimizing a sum of squares of error functions of all key points.

In an embodiment, the combining the movement parameters to acquire the three-dimensional coordinate prediction values of the target includes the following steps.

According to a state vector S_{k-1|k-1} of the target at a moment k−1, acquiring a prediction result S_{k|k-1} of the state vector at a moment k through a state transition matrix Φ:

S_{k|k-1}=ΦS_{k-1|k-1},
where the state vector is

$${S}_{k} ( {x}_{k} , {y}_{k} , {z}_{k} , {\dot{x}}_{k} , {\dot{y}}_{k} , {\dot{z}}_{k} ) , Φ = [ \begin{matrix}1 & 0 & 0 & t & 0 & 0 \\ 0 & 1 & 0 & 0 & t & 0 \\ 0 & 0 & 1 & 0 & 0 & t \\ 0 & 0 & 0 & 1 & 0 & 0 \\ 0 & 0 & 0 & 0 & 1 & 0 \\ 0 & 0 & 0 & 0 & 0 & 1\end{matrix} ] ,$$

and t represents a time interval between consecutive moments.

The three-dimensional coordinate prediction value of the target at the moment k is S′_{k|k-1}=R_{k|k-1}S_{k|k-1}+T_{k|k-1}, and the movement parameters R_{k|k-1} and T_{k|k-1} are respectively a three-dimensional movement rotation matrix of the apparatus and a translation vector of the apparatus determined by combining the three-dimensional coordinates of the key points at the moments k−1 and k.

In an embodiment, the three-dimensional coordinate unbiased estimation value S_{k|k} of the target is:

S_{k|k}=S′_{k|k-1}+Kₖ(Mₖ−HS′_{k|k-1}),
where S′_{k|k-1} is the three-dimensional coordinate prediction value, Mₖ is the three-dimensional coordinate observation value, H is an observation transformation matrix,

$$H = [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ] ,$$

and Kₖ is a filter gain matrix, and/or

Kₖ=P′_{k|k-1}H^{T}(H P′_{k|k-1}H^{T}+Rₖ)⁻¹

P′_{k|k-1}=R_{k|k-1}P_{k|k-1}R_{k|k-1}, and

P_{k|k-1}=ΦP_{k-1|k-1}Φ^{T}+Qₖ
where P_{k-1|k-1} is a covariance matrix at a moment k−1, Φ is a state transition matrix, Qₖ and Rₖ both represent noise, R_{k|k-1} is a three-dimensional movement rotation matrix of the apparatus determined by combining three-dimensional coordinates of key points at moments k−1 and k, P_{k|k-1} is a predicted covariance matrix at the moment k, P′_{k|k-1} is the covariance matrix at the moment k after considering the movement parameters.

In an embodiment, the driving the end joint of the manipulator to rotate by using the two-dimensional image of the target includes the following step.

The two-dimensional image is inputted into a network model, and a rotation angle of the end joint is outputted. The network model is acquired by training with a sample group composed of the determined two-dimensional image of the target and the rotation angle of the end joint, or the network model is acquired by learning a predetermined mapping relationship between the two-dimensional image of the target and the rotation angle of the end joint.

The network model includes: a convolutional neural network, a global average pooling layer, and a fully-connected layer. The convolutional neural network contains channel-by-channel convolution or point-by-point convolution to extract high-dimensional features in the two-dimensional image, the global average pooling layer is used to fuse the high-dimensional features in a spatial dimension, and the fully-connected layer contains one output node for predicting the rotation angle of the end joint according to the fused high-dimensional features.

A loss function [symbol] of the network model is:

$$ℒ = \frac{1}{N} {\sum }_{i = 1}^{N} \{ \begin{matrix}0.5 \times {( {r}_{i} - {Φ}_{r} ( {I}_{i} ) )}^{2} , & \vert {r}_{i} - {Φ}_{r} ( {I}_{i} ) \vert < 1 \\ \vert {r}_{i} - {Φ}_{r} ( {I}_{i} ) \vert - 0.5 , & other cases\end{matrix} ,$$

where N represents the number of samples, rᵢ represents an expected rotation angle, Φᵣ(Iᵢ) represents the rotation angle predicted by the network model, and Iᵢ represents the two-dimensional image.

In the second aspect, the disclosure further provides a system for binocular visual servoing of an underwater vehicle-dual-arm manipulator autonomous operation, and an underwater vehicle and a dual-arm manipulator form an apparatus configured to perform an underwater operation. The system includes an image acquisition unit, a target observation unit, a target prediction unit, an unbiased estimation unit, and servo control unit.

The image acquisition unit is configured to acquire a two-dimensional image and a depth image of a target in front of an underwater vehicle-dual-arm manipulator.

The target observation unit is configured to input the two-dimensional image into a target detector to obtain a target identification frame, based on a search region of three-dimensional coordinate on the depth image, which is determined by the target identification frame, and in combination with the depth image, eliminate pixel points with invalid depth values in the search region, retain the pixel points with median depth values based on a sorting of depth values, thereby determining a three-dimensional coordinate observation value of the target.

The target prediction unit is configured to determine three-dimensional coordinates of a plurality of key points on the two-dimensional image with reference to the depth image, acquire movement parameters of the apparatus by combining the three-dimensional coordinates of the key points at two consecutive moments, treat three-dimensional coordinates and a three-dimensional velocity of the target as state vectors, treat the three-dimensional coordinate observation value of the target as an observation vector, and acquire a three-dimensional coordinate prediction value of the target by combining the movement parameters.

The unbiased estimation unit is configured to fuse the three-dimensional coordinate observation value and the three-dimensional coordinate prediction value based on a Kalman filtering method and obtain a three-dimensional coordinate unbiased estimation value of the target.

The servo control unit is configured to drive the apparatus to move to a predetermined position with reference to the three-dimensional coordinate unbiased estimation value of the target, control an effector of at least one manipulator to move toward the target according to the three-dimensional coordinate unbiased estimation value of the target, and drive an end joint of a corresponding effector to rotate by using the two-dimensional image of the target, so that after the at least one manipulator reaches the target, the effector thereof is able to effectively clamp the target.

In the third aspect, the disclosure further provides an electronic apparatus including at least one memory configured to store a computer program and at least one processor configured to execute the program stored by the memory and execute the method according to any one of the first aspect or any embodiment of the first aspect when the program stored by the memory is executed.

In the fourth aspect, the disclosure further provides a computer-readable storage medium, and the computer-readable storage medium stores a computer program. When the computer program is running on a processor, the processor is enabled to execute the method according to any one of the first aspect or any embodiment of the first aspect.

In the fifth aspect, the disclosure further provides a computer program product. When the computer program product runs on a processor, the processor is enabled to execute the method according to any one of the first aspect or any embodiment of the first aspect.

To sum up, the above technical solutions provided by the disclosure have the following beneficial effects compared with the related art.

The disclosure provides a system for binocular visual servoing of an underwater vehicle-dual-arm manipulator autonomous operation, and a lightweight deep neural network target detector is designed to implement rapid recognition of the operation target. A method for continuously estimating the three-dimensional coordinates of the target is designed, so compared to the positioning methods of the related art, the continuous positioning method disclosed in the disclosure does not lose target position under conditions such as disparity holes and missed detection. The influence of nonlinear movement of the hull on positioning is also considered, so robustness is improved. Subsequently, the disclosure a method for decoupled vision servoing. The operation execution process of the underwater vehicle and the manipulator is divided into the hull dynamic positioning based on the target position and the manipulator target grasping based on the target position and image. Further, the neural network-based manipulator end joint controller is designed to adjust the grasping angle, so that the autonomous operation problem under unknown target posture is solved, the autonomy and intelligence of underwater operations are effectively improved, and the operation success rate is increased.

### BRIEF DESCRIPTION OF THE DRAWINGS

FIG. 1 is a flow chart of a method for binocular visual servoing of an underwater vehicle-dual-arm manipulator autonomous operation provided by an embodiment of the disclosure.

FIG. 2 is a schematic photo of an apparatus formed by an underwater vehicle-dual-arm manipulator provided by an embodiment of the disclosure.

FIG. 3 is a block diagram of decoupled vision servoing provided by an embodiment of the disclosure.

FIG. 4 is a block diagram of a lightweight deep neural network target detector provided by an embodiment of the disclosure.

FIG. 5 is a block diagram of a neural network-based end joint controller of a manipulator arm provided by an embodiment of the disclosure.

FIG. 6 is a flow process photo of a task completion status from the first-person view during the autonomous valve opening and closing operations provided by an embodiment of the disclosure.

FIG. 7 is a flow process photo of a task completion status from the first-person view during the autonomous pipeline handling operation provided by an embodiment of the disclosure.

FIG. 8 is an architecture view of a system for binocular visual servoing of an underwater vehicle-dual-arm manipulator autonomous operation provided by an embodiment of the disclosure.

FIG. 9 is an architecture view of an electronic apparatus provided by an embodiment of the disclosure.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the disclosure merely and are not used to limit the disclosure.

In the disclosure, the term “and/or” is an association relationship describing associated objects, indicating that three relationships may exist. For instance, A and/or B may represent: A exists alone, A and B together exist, and B exists alone, these three situations. In the disclosure, the symbol “/” indicates that the associated objects have an “or” relationship. For instance, A/B represents A or B.

In the embodiments of the disclosure, words such as “exemplary” or “for example” are used to represent examples, illustrations, or explanations. Any embodiment or design described in the embodiments of the disclosure as “exemplary” or “for example” is not intended to be construed as preferred or advantageous over other embodiments or designs. Rather, the use of the words “exemplary” or “for example” is intended to present the concept in a concrete manner.

In the embodiments of the disclosure, unless otherwise specified, “plurality” means two or more than two. For instance, a plurality of key points refers to two or more than two key points, etc.

The embodiments of the disclosure are described in the following paragraphs together with the accompanying drawings in the embodiments of the disclosure.

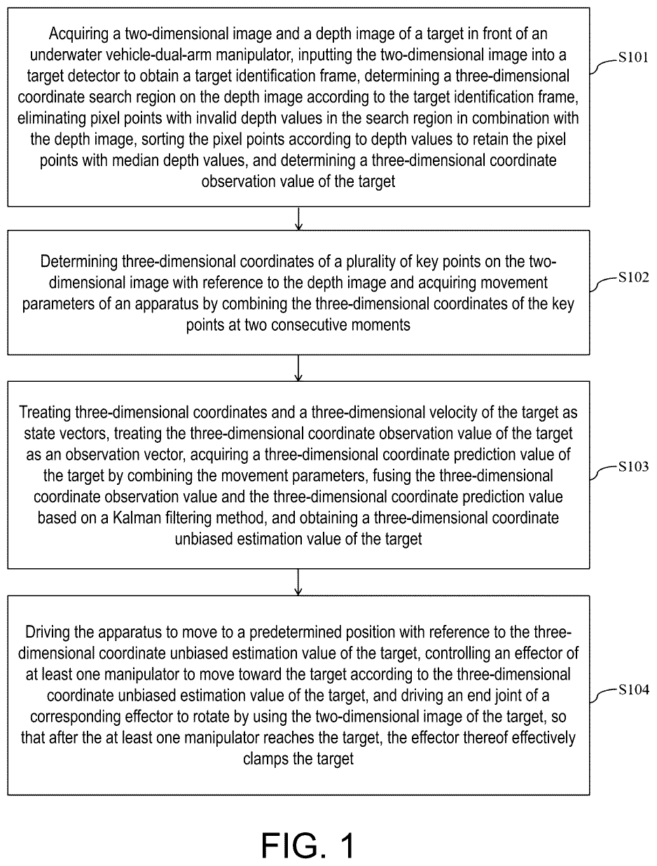

FIG. 1 is a flow chart of a method for binocular visual servoing of an underwater vehicle-dual-arm manipulator autonomous operation provided by an embodiment of the disclosure. As shown in FIG. 1, the following steps are included.

In step S101, a two-dimensional image and a depth image of a target in front of an underwater vehicle-dual-arm manipulator are acquired, the two-dimensional image is inputted into a target detector to obtain a target identification frame, pixel points with invalid depth values in the search region are eliminated based on a search region of three-dimensional coordinate on the depth image, which is determined by the target identification frame, and in combination with the depth image, the pixel points with median depth values are retained based on a sorting of depth values, thereby determining a three-dimensional coordinate observation value of the target.

In step S102, three-dimensional coordinates of a plurality of key points on the two-dimensional image are determined with reference to the depth image, and movement parameters of the apparatus are acquired by combining the three-dimensional coordinates of the key points at two consecutive moments.

In step S103, three-dimensional coordinates and a three-dimensional velocity of the target are treated as state vectors, the three-dimensional coordinate observation value of the target is treated as an observation vector, a three-dimensional coordinate prediction value of the target is acquired in combination with the movement parameters, the three-dimensional coordinate observation value and the three-dimensional coordinate prediction value are fused based on a Kalman filtering method, and a three-dimensional coordinate unbiased estimation value of the target is acquired.

In step S104, the apparatus is driven to move to a predetermined position with reference to the three-dimensional coordinate unbiased estimation value of the target, an effector of at least one manipulator is controlled to move toward the target according to the three-dimensional coordinate unbiased estimation value of the target, and an end joint of a corresponding effector is driven to rotate by using the two-dimensional image of the target, so that after the manipulator reaches the target, the effector thereof effectively clamps the target.

The purpose of the disclosure is to design a vision servo method to implement the execution of an autonomous operation of an underwater vehicle-manipulator system and to continuously locate targets through visible light cameras under conditions of insufficient illumination and complex water quality. In addition, the vision servo method has the capability to adapt to different types and postures of targets, ensures adaptive adjustment of grasping angles, and achieves autonomy and intelligence of the underwater vehicle-manipulator system.

In a more specific embodiment, the above method may specifically include the following steps.

Images acquired through a forward-looking camera by the underwater vehicle and manipulator system at a previous moment and a current moment are acquired.

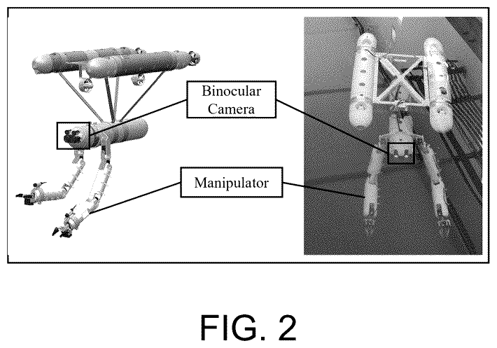

A structure of the underwater vehicle-manipulator system is shown in FIG. 2.

A lightweight underwater target detector is designed based on a deep neural network, so as to rapidly acquire types of targets and their pixel coordinates contained in a current image.

A field-of-view depth map is generated from binocular images through camera intrinsic and extrinsic parameters, a three-dimensional information search range of the target on the depth map is adaptively calculated based on a target shape and pixel coordinates, invalid values and outliers therein are eliminated, and remaining valid values are averaged to acquire the three-dimensional coordinate observation value of the target at the current moment.

Key points on a previous moment image are detected, pixel coordinates of corresponding points on the current image are acquired by using optical flow estimation, three-dimensional coordinates corresponding to key points on depth maps of two consecutive frames are accordingly acquired, and a three-dimensional movement matrix of the system at two consecutive moments is calculated based on least squares.

The three-dimensional coordinates of the target at the current moment are preliminarily estimated through a linear movement model, and the three-dimensional coordinate prediction value of the target at the current moment is calculated further based on the movement matrix and the value. The three-dimensional coordinate observation value and prediction value of the target are fused through Kalman gain, so as to implement unbiased estimation of the three-dimensional coordinates of the target in a vehicle-mounted coordinate system at the current moment.

A dynamic positioning error of the underwater vehicle and manipulator system is acquired based on the current three-dimensional coordinates and desired three-dimensional coordinates of the target, and the underwater vehicle and manipulator system is controlled to navigate to a desired position. The current three-dimensional coordinates of the target are set as a desired position of an end of the manipulator, desired angles of joints of the manipulator are calculated based on a kinematic model, and a difference value between the desired angles and current angles is used as a control variable to control the movement of the manipulator. A manipulator end joint controller is designed based on a deep neural network, a target image is treated as input, and a rotation angle is outputted to control a grasping angle of an end effector, so as to adapt to randomness of a posture of the target.

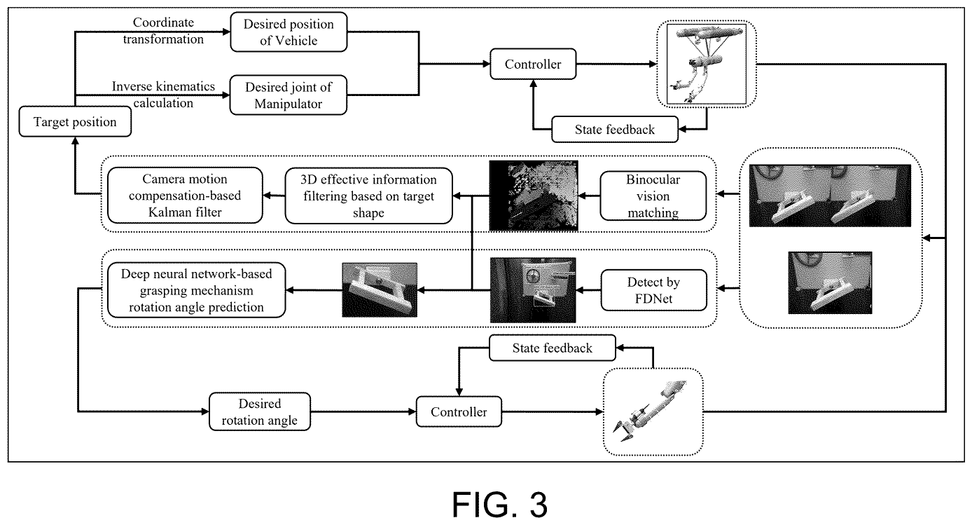

Specifically, the decoupled visual servo method for an autonomous operation task of the underwater vehicle-manipulator system disclosed in this disclosure, as shown in FIG. 3, includes the following.

(1) A lightweight deep neural network is designed to rapidly identify a target in an image. (2) A method for acquiring a three-dimensional coordinate value of the target based on binocular stereo vision is designed. (3) A Kalman filtering method based on movement compensation of nonlinear movement of a camera is provided to implement continuous target positioning. (4) A decoupling scheme for converting a target position and an image into control commands is designed.

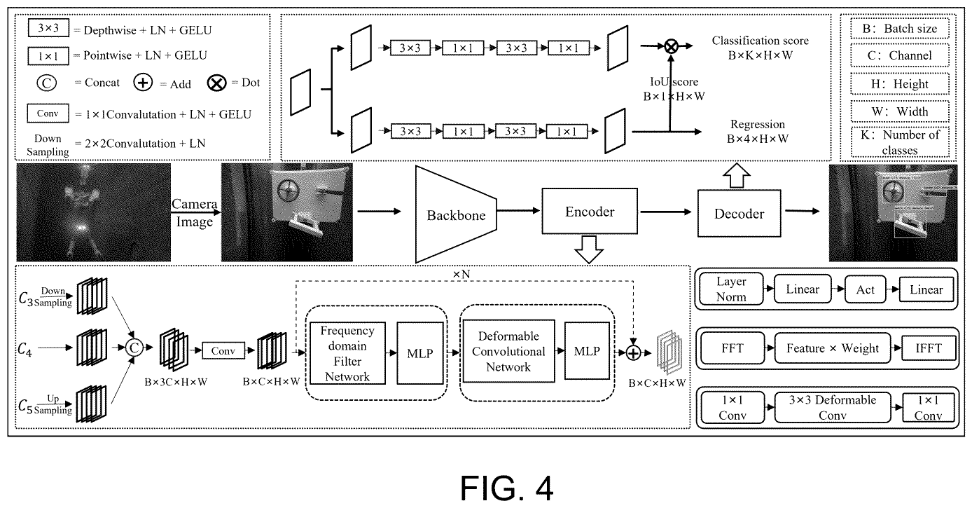

The structure of the designed lightweight underwater target detector, as shown in FIG. 4, includes: a lightweight feature extractor configured to extract a high-level feature from an image, an encoder combining global frequency domain filtering with deformable convolution for enhancing model robustness, and a decoder based on depthwise separable convolution for rapidly outputting target categories and their pixel coordinates from features outputted by the encoder.

Specifically, in order to enhance the model's expressive capability and adaptability to targets of different sizes, in the embodiments of this disclosure, an encoder based on frequency domain filtering and deformable convolution is designed. The features extracted through the feature extractor are adjusted to a same scale and spliced in a channel dimension to acquire a feature F∈C^{H×W×3D}. F is dimensionally reduced through convolution to acquire F′∈C^{H×W×D}. F′ is converted to a frequency domain by using fast Fourier transform, and a spectrum f′ thereof is obtained. A learnable filter K∈C^{H×W×D} is used to adjust information within the spectrum:

\dot{f}′=k⊙f′,
where ⊙ is element-by-element multiplication. Next, inverse fast Fourier transform is used to convert it back to the time domain, and a new F is obtained.

The newly acquired features pass through a multi-layer perceptron to further enhance the model's nonlinear expressive capability.

The features processed through frequency domain filtering are processed by a deformable convolution to enhance the expressive capability for targets of different sizes. The similarly processed features pass through a multi-layer perceptron to enhance the model's nonlinear expressive capability.

The features processed through the above encoder are fed into a decoder composed of depthwise separable convolution for pixel-by-pixel prediction of target categories and the center pixel coordinates and sizes of identification frames.

Further, the proposed method for acquiring the target three-dimensional coordinate value based on binocular stereo vision has the following specific process.

According to the target identification frame acquired by the detector, the pixel coordinates of the target center are calculated as the center of the search region, and then a width and a height of the search region are calculated according to a size of the target identification frame. The corresponding three-dimensional coordinates are extracted from the corresponding positions of each pixel in the region on the depth map to form a set P. Invalid values are eliminated through a large threshold, i.e., if P>10000, it is directly deleted, and new set P′ is acquired.

An upper quartile Q₁ and a lower quartile Q₂ of the set are calculated:

$${Q}_{1} = \frac{n + 1}{4} , {Q}_{2} = \frac{3 ( n + 1 )}{4} ,$$

where, n is the size of the set. If Q₁ and Q₂ are integers, the values at corresponding positions may be treated as thresholds ε₁ and ε₂. Herein, only the three-dimensional information satisfying the following conditions needs to be retained:

ε₁<pᵢ<ε₂.

If Q₁ and Q₂ are not integers, they are respectively rounded up and down, and the four values ε^{up}₁, ε^{down}₁, ε^{up}₂, ε^{down}₂ at corresponding positions are obtained. The threshold calculation formula herein is:

ε₁=0.25×ε^{up}₁+0.75×ε^{down}₁ and ε₂=0.75×ε^{up}₂+0.25×ε^{down}₂.

An average value of the valid values in the new set pc is treated as the three-dimensional coordinate observation value of the target at the current moment:

$${p}_{target} = \frac{1}{n} {\sum }_{p ∈ {p}_{c}} ( {x}_{p} , {y}_{p} , {z}_{p} ) .$$

The process of the proposed Kalman filtering method based on movement compensation of nonlinear movement of the camera is as follows.

First, it is necessary to estimate a nonlinear movement matrix of a hull between two consecutive frames.

Shi-Tomasi corner points are detected on the image at the previous moment, and three-dimensional coordinates P of these key points are acquired at corresponding positions on the depth map. Corresponding key points are found on the current image through optical flow estimation, and the three-dimensional coordinates P′ of these key points at corresponding positions on the current depth map are acquired. The following error function is defined:

eᵢ=pᵢ−(Rp′ᵢ+T).

According to the above error, the following least squares problem is defined:

$${min}_{R , T} \frac{1}{2} {\sum }_{i = 1}^{n} {‖ ( {p}_{i} - ( {Rp}_{i}^{′} + T ) ) ‖}_{2}^{2} .$$

By solving the above problem, a three-dimensional movement rotation matrix R and a translation vector T of the underwater vehicle and manipulator system between two frames can be acquired.

Next, a state vector Sₖ and an observation vector Mₖ of the three-dimensional coordinates of the target are respectively defined as:

Sₖ=(xₖ,yₖ,zₖ,\dot{x}ₖ,\dot{y}ₖ,żₖ) and Mₖ=(Mxₖ,Myₖ,Mzₖ)

A state transition matrix Φ and an observation transformation matrix H are defined as:

$$Φ = [ \begin{matrix}0 & 1 & 0 & 0 & t & 0 & 0 \\ 0 & 0 & 1 & 0 & 0 & t & 0 \\ 0 & 0 & 0 & 1 & 0 & 0 & t \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ] and H = [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ] .$$

Finally, the three-dimensional coordinate unbiased estimation process of the target is: according to a state vector S_{k-1|k-1} of the target at a moment k−1, a prediction result S_{k|k-1} of the state vector at a moment k is acquired through a state transition matrix:

S_{k|k-1}=ΦS_{k-1|k-1},
where S_{k-1|k-1}=Sₖ₋₁, and a state variable of the previous moment is determined by the unbiased estimation value of the previous moment and the movement velocity of the apparatus.

According to a covariance matrix P_{k-1|k-1} of the target at the previous moment, the covariance matrix P_{k|k-1} at the current moment is predicted through the state transition matrix:

P_{k|k-1}=ΦP_{k-1|k-1}Φ^{T}+Qₖ.

The rotation matrix R_{k|k-1} and the translation vector T_{k|k-1} from an estimation result of the nonlinear movement of the hull are added into the prediction result S_{k|k-1} of the state vector at the current moment together:

S′_{k|k-1}=R_{k|k-1}S_{k|k-1}+T_{k|k-1}.

The rotation matrix R_{k|k-1} from the estimation result of the nonlinear movement of the hull is added into the prediction result P_{k|k-1} of the covariance matrix at the current moment:

P′_{k|k-1}=R_{k|k-1}P_{k|k-1}R_{k|k-1}.

The filter gain matrix Kₖ is calculated through the predicted covariance matrix P′_{k|k-1} and the observation matrix H:

Kₖ=P′_{k|k-1}H^{T}(H P′_{k|k-1}H^{T}+Rₖ)⁻¹.

Through the filter gain matrix Kₖ, the prediction result S′_{k|k-1} and an observation result Mₖ at the moment k are fused to obtain unbiased estimation S_{k|k} corresponding to the three-dimensional coordinates of the current target:

S_{k|k}=S′_{k|k-1}+Kₖ(Mₖ−HS′_{k|k-1}).

The covariance matrix P′_{k|k-1} is updated:

P_{k|k}=(I−KₖH)P′_{k|k-1}.

The decoupling scheme of converting the target position and image into control commands divides the autonomous operation of the underwater vehicle-manipulator system into two parts as follows.

In the first part, the hull is set as a dynamic positioning task. An interpolation

$${‖ {p}_{t}^{*} - {p}_{t} ‖}_{2}^{2}$$

between the three-dimensional coordinates pₜ of the target at the current moment in a hull coordinate system and the desired coordinates pₜ^{*} is calculated as an control error and is inputted into an underlying controller to drive the underwater vehicle to approach the target and remain stationary. Herein, the approaching refers to the distance between the apparatus and the target being less than a predetermined distance threshold, for example 0.5 m.

In the second part, the three-dimensional coordinates pₜ^{c} of the target in a camera coordinate system are converted to a base coordinate system of the manipulator to obtain pₜ^{b}, and the desired value pₑₑ^{*} of the manipulator end position is set as pₜ^{b}. A relationship between the target image and the rotation angle of the end joint is encoded as a learnable mapping g:Iₜ→rₑₑ and is learned by a deep neural network Φᵣ:

rₑₑ=Φᵣ(Iₜ,wᵣ),
where rₑₑ represents the rotation angle, Iₜ represents the target image, and wᵣ represents a network weight.

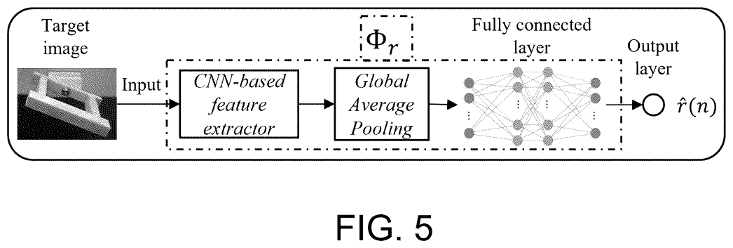

Further, the specific form of the above-mentioned manipulator end joint controller based on a deep neural network, as shown in FIG. 5, includes: a convolutional neural network, a global average pooling layer, and a fully-connected layer. The convolutional neural network contains channel-by-channel convolution or point-by-point convolution to extract high-dimensional features from the operation target image. Global average pooling is used to fuse high-dimensional features in a spatial dimension. The fully-connected layer contains an output node for predicting the rotation angle according to the fused features.

In the disclosure, the following embodiments are adopted to verify the above technical scheme:

The basic parameters of the underwater vehicle-manipulator system used in this embodiment are shown in Table 1.

TABLE 1
Basic parameters of underwater vehicle-manipulator system

| Parameter | | | |
|---|---|---|---|
| Name | Parameter Description | Parameter Value | |
| Mᵥ | underwater vehicle mass | 226 | kg |
| Lᵥ | underwater vehicle length | 1.2 | m |
| Dᵥ | underwater vehicle equivalent diameter | 0.6 | m |
| Gᵥ | underwater vehicle gravity | 2217N | |
| Bᵥ | underwater vehicle buoyancy | 2217N | |
| I_{v,xx} | underwater vehicle inertia moment-X | 8 | kg · m² |
| I_{v,yy} | underwater vehicle inertia moment-Y | 20 | kg · m² |
| I_{v,zz} | underwater vehicle inertia moment-Z | 20 | kg · m² |
| M₁ | mass of manipulator link 1 | 3.39 | kg |
| M₂ | mass of manipulator link 2 | 3.39 | kg |
| L₁ | length of manipulator link 1 | 0.5 | m |
| L₂ | length of manipulator link 2 | 0.5 | m |
| D₁ | diameter of manipulator link 1 | 0.16 | m |
| D₂ | diameter of manipulator link 2 | 0.16 | m |
| Cₘ | inertia coefficient | 1.0 | |
| C_{d} | drag coefficient | 1.1 | |
| ρ | water density | 1000 | kg · m⁻³ |
| g | gravitational acceleration | 9.8 | m · s⁻² |

In this embodiment, a pool experiment is adopted to demonstrate the effectiveness and advancement of the method proposed in the disclosure. In the experiment, the underwater vehicle-manipulator will complete various autonomous opening and closing tasks of valves and autonomous pipeline transportation tasks with dual arms, so as to demonstrate the effectiveness of the control method proposed in the disclosure. The relevant parameter settings are introduced in the following paragraphs. An initial distance between the underwater vehicle-manipulator and an operation target is a random number between [1 m, 2 m]. When the hull performs a dynamic positioning task, the desired position of the target in the hull coordinate system is [0, 0, 0.5 m], with an error of 20 cm. The error between an end position of the manipulator and the desired position needs to be less than 5 cm.

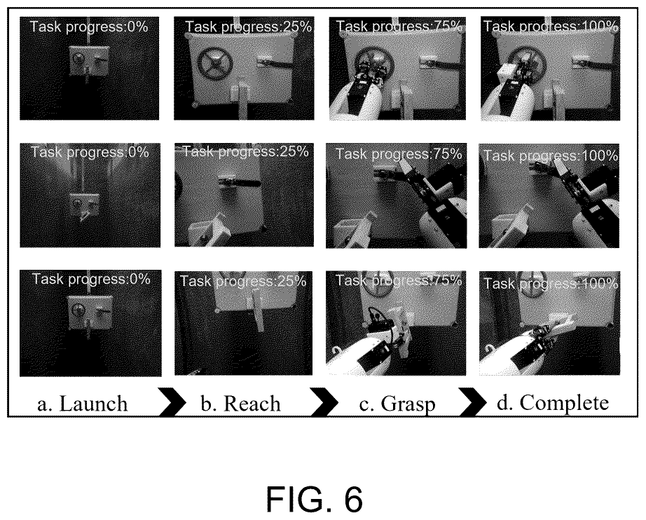

The experimental results show that when the method of the disclosure is adopted, the discontinuity of target positioning is obviously overcome. The joints of the manipulator arms complete rotation according to the position and image of the target, making the end positions approach the valves. FIG. 6 is the first-person view image during task execution. From FIG. 6, it may be concluded that when the method of the disclosure is adopted, the underwater vehicle-manipulator may autonomously complete the opening and closing operations on different valves in random postures.

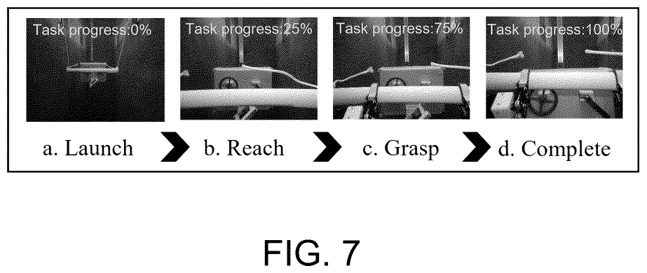

The experimental results show that when the method of the disclosure is adopted, the hull successfully approaches the target and performs dynamic positioning, and the joints of the two manipulator arms complete rotation according to the position and image of the target, making their end positions approach the pipeline. FIG. 7 shows the first-person view image during task execution. From FIG. 7, it may be concluded that when the method provided by the embodiments of the disclosure is adopted, the underwater vehicle-manipulator may complete grasping of the pipeline using both hands.

In view of the foregoing, the disclosure discloses a method for binocular visual servoing of an underwater vehicle-dual-arm manipulator autonomous operation. Under the influences of poor underwater lighting conditions, complex interferences, and hull oscillation, the underwater vehicle-manipulator system faces considerable challenges in autonomously completing operations through its own sensing apparatus. To ensure the rapidity of target detection, a lightweight deep neural network target detector is designed. To avoid losing target position in cases of disparity holes and missed detection, a continuous estimation method for target three-dimensional coordinates is designed, while considering the influence of nonlinear movement of the hull on positioning to improve robustness. Subsequently, the disclosure designs a scheme to convert the target position and image into control commands. The operation execution process of the underwater vehicle and the manipulator is divided into the hull dynamic positioning based on the target position and the manipulator target grasping based on the target position and image. Further, a neural network-based manipulator end joint controller is designed to adjust the grasping angle, so that the autonomous operation problem under unknown target posture is solved, and the operation success rate is increased.

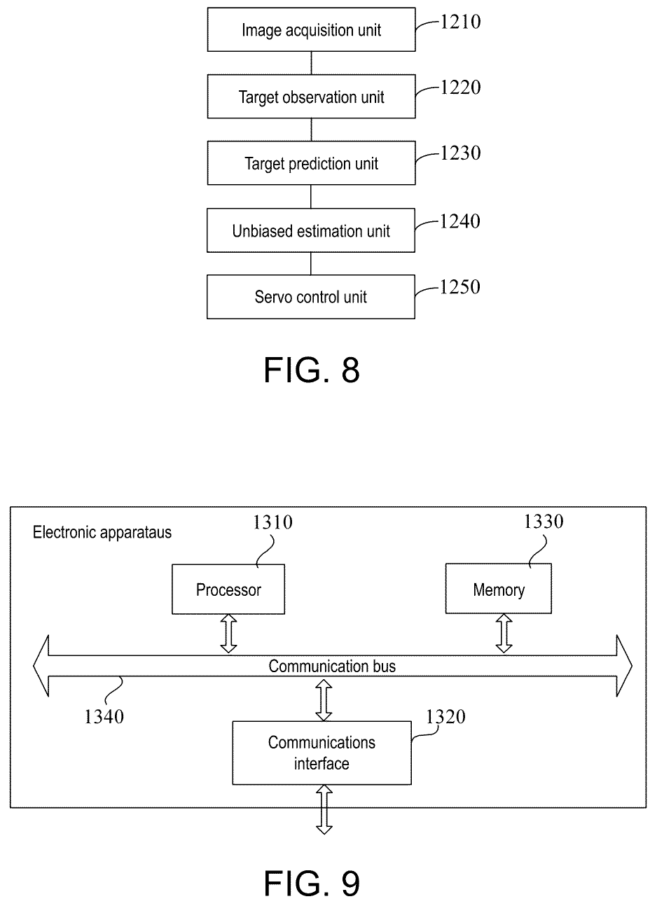

FIG. 8 is an architecture view of a system for binocular visual servoing of an underwater vehicle-dual-arm manipulator autonomous operation provided by an embodiment of the disclosure. As shown in FIG. 8, the following are included.

An image acquisition unit 1210 is included and is configured to acquire a two-dimensional image and a depth image of a target in front of an underwater vehicle-dual-arm manipulator.

A target observation unit 1220 is included and is configured to input the two-dimensional image into a target detector to obtain a target identification frame, based on a search region of three-dimensional coordinate on the depth image, which is determined by the target identification frame, and in combination with the depth image, eliminate pixel points with invalid depth values in the search region, retain the pixel points with median depth values based on a sorting of depth values, thereby determining a three-dimensional coordinate observation value of the target.

A target prediction unit 1230 is included and is configured to determine three-dimensional coordinates of a plurality of key points on the two-dimensional image with reference to the depth image, acquire movement parameters of the apparatus by combining the three-dimensional coordinates of the key points at two consecutive moments, treat three-dimensional coordinates and a three-dimensional velocity of the target as state vectors, treat the three-dimensional coordinate observation value of the target as an observation vector, and acquire a three-dimensional coordinate prediction value of the target by combining the movement parameters.

An unbiased estimation unit 1240 is included and is configured to fuse the three-dimensional coordinate observation value and the three-dimensional coordinate prediction value based on a Kalman filtering method and obtain a three-dimensional coordinate unbiased estimation value of the target.

A servo control unit 1250 is included and is configured to drive the apparatus to move to a predetermined position with reference to the three-dimensional coordinate unbiased estimation value of the target, control an effector of at least one manipulator to move toward the target according to the three-dimensional coordinate unbiased estimation value of the target, and drive an end joint of a corresponding effector to rotate by using the two-dimensional image of the target, so that after the at least one manipulator reaches the target, the effector thereof may effectively clamp the target.

It should be understood that the abovementioned system is used to perform the method in the abovementioned embodiments. The implementation principles and technical effects of the corresponding program units in the system are similar to those described in the above method. The working procedure of the system can be referred to the corresponding procedure of the method in the foregoing paragraphs, so description thereof is not repeated herein.

Based on the method in the above embodiments, the embodiments of the disclosure provide an electronic apparatus, and as shown in FIG. 9, the electronic apparatus may include: a processor 1310, a communications interface 1320, a memory 1330, and a communication bus 1340, where the processor 1310, the communications interface 1320, and the memory 1330 complete communication with one another through the communication bus 1340. The processor 1310 may call logic instructions in the memory 1330 to execute the method provided by the embodiments in the foregoing paragraphs.

In addition, the logic instructions in the aforementioned memory 1330 may be implemented in the form of software functional units and may be stored in a computer-readable storage medium when being sold or used as independent products. Based on such understanding, the technical solution of the disclosure essentially, or the part that contributes to the related art, or the part of the technical solution may be embodied in the form of a software product. The computer software product is stored in a storage medium and includes several instructions for causing a computer apparatus (which may be a personal computer, server, or network device, etc.) to execute all or part of the steps of the method described in various embodiments of the disclosure.

Based on the method in the above embodiments, an embodiment of the disclosure provides a computer-readable storage medium, and the computer-readable storage medium stores a computer program. When the computer program is running on the processor, the processor is enabled to execute the method in the above embodiments.

Based on the method in the above embodiments, an embodiment of the disclosure provides a computer program product. When the computer program product is running on the processor, the processor is enabled to execute the method in the above embodiments.

It can be understood that the processor in the embodiments of the disclosure may be a central processing unit (CPU), may be a general-purpose processor, a digital signal processor (DSP), an application specific integrated circuit (ASIC), or a field programmable gate array (FPGA), or may be a programmable logic device, a transistor logic device, a hardware component, or any combination thereof. The general-purpose processor may be a microprocessor or may also be any conventional processor.

The method steps in the embodiments of the disclosure may be implemented by hardware or by a processor executing software instructions. The software instructions may be formed by a corresponding software module, and the software module may be stored in a random access memory (RAM), a flash memory, a read-only memory (ROM), a programmable rom (PROM), an erasable PROM (EPROM), an electrically EPROM (EEPROM), a register, a hard disk, a mobile hard disk, a CD-ROM, or any other form of storage media well known in the art. An exemplary storage medium is coupled to the processor, such that the processor can read information from the storage medium and write information to the storage medium. Certainly, the storage medium may also be an integral part of the processor. The processor and storage medium may be located in an ASIC.

In the above embodiments, it may be implemented entirely or partially through software, hardware, firmware, or any combination thereof. When implemented using software, it may be implemented entirely or partially in the form of a computer program product. The computer program product includes one or more computer instructions. When the computer program instructions are loaded and executed on a computer, the processes or functions according to the embodiments of the disclosure are generated entirely or partially. The computer may be a general purpose computer, a special purpose computer, a computer network, or other programmable apparatuses. The computer instructions may be stored in or transmitted through a computer-readable storage medium. For instance, the computer instruction may be transmitted from one website, computer, server, or data center to another website, computer, server, or data center by wired (e.g., coaxial cable, optical fiber, digital subscriber line (DSL)) or wireless (e.g., infrared, wireless, microwave, etc.) means. The computer-readable storage medium may be any available medium that may be accessed by a computer or a data storage device such as a server or a data center integrated with one or more available media. The available medium may be a magnetic medium (e.g., a floppy disk, a hard disk, or a magnetic tape), an optical medium (e.g., DVD), or a semiconductor medium (e.g., a solid state disk (SSD)), etc.

It can be understood that the various numerical numbers involved in the embodiments of the disclosure are only for convenience of description and are not used to limit the scope of the embodiments of the disclosure.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A method for binocular visual servoing of an underwater vehicle-dual-arm manipulator autonomous operation, wherein an underwater vehicle and a dual-arm manipulator form an apparatus configured to perform an underwater operation, the method comprises:
acquiring a two-dimensional image and a depth image of a target in front of the underwater vehicle-dual-arm manipulator; inputting the two-dimensional image into a target detector to obtain a target identification frame; based on a search region of three-dimensional coordinate on the depth image, which is determined by the target identification frame, and in combination with the depth image, eliminating pixel points with invalid depth values in the search region, retaining pixel points with median depth values based on a sorting of depth values, thereby determining a three-dimensional coordinate observation value of the target;
determining three-dimensional coordinates of a plurality of key points on the two-dimensional image with reference to the depth image and acquiring movement parameters of the apparatus by combining the three-dimensional coordinates of the key points at two consecutive moments;
treating three-dimensional coordinates and a three-dimensional velocity of the target as state vectors, treating the three-dimensional coordinate observation value of the target as an observation vector, acquiring a three-dimensional coordinate prediction value of the target by combining the movement parameters, fusing the three-dimensional coordinate observation value and the three-dimensional coordinate prediction value based on a Kalman filtering method, and obtaining a three-dimensional coordinate unbiased estimation value of the target; and
driving the apparatus to move to a predetermined position with reference to the three-dimensional coordinate unbiased estimation value of the target, controlling an effector of at least one manipulator to move toward the target according to the three-dimensional coordinate unbiased estimation value of the target, and driving an end joint of a corresponding effector to rotate by using the two-dimensional image of the target, so that after the at least one manipulator reaches the target, the effector thereof effectively clamps the target;
wherein determining the three-dimensional coordinate observation value of the target comprises:
treating a center point within the target identification frame as a center of the search region on the depth image and determining a width and a height of the search region according to a size of the target identification frame;
matching the depth image with the two-dimensional image according to pixel coordinates and acquiring the depth value of each pixel point within the search region;
sorting all pixel points within the search region according to the depth values;
eliminating invalid pixel points in the search region based on a predetermined sorting threshold and acquiring a new pixel point set;
keeping middle pixel points by order in the new pixel point set; and
averaging three-dimensional coordinates of all retained pixel points and obtaining the three-dimensional coordinate observation value of the target;
wherein retaining the pixel points with the median depth values in the new pixel point set comprises:
calculating an upper quartile Q₁ and a lower quartile Q₂ of a sorting in the new pixel point set:
$${Q}_{1} = \frac{n + 1}{4} , {Q}_{2} = \frac{3 ( n + 1 )}{4} ,$$
wherein, n is a total number of pixel points comprised in the new pixel point set;
treating depth values at positions corresponding to Q₁ and Q₂ as thresholds ε₁ and ε₂ if Q₁ and Q₂ are integers;
performing rounding up and rounding down if Q₁ and Q₂ are not integers, obtaining Q^{up}₁, Q^{down}₁, Q^{up}₂, and Q^{down}₂, and obtaining four depth values ε^{up}₁, ε^{down}₁, ε^{up}₂, and ε^{down}₂ at corresponding positions, ε₁=0.25×ε^{up}₁+0.75×ε^{down}₁ and ε₂=0.75×ε^{up}₂+0.25×ε^{down}₂; and
retaining pixel points when a depth value pᵢ satisfies ε₁<pᵢ<ε₂.

2. The method according to claim 1, wherein the target detector comprises: a feature extractor, an encoder, and a decoder;
the feature extractor is configured to extract features of the target in the two-dimensional image,
the encoder is configured to adjust the features extracted by the feature extractor to a same scale and splice the features in a channel dimension to acquire a feature F, perform dimensionality reduction on the feature F through convolution to acquire a feature F′, convert the feature F′ to a frequency domain using fast Fourier transform corresponding to a frequency spectrum f′, adjust information in the frequency spectrum f′ through a learnable filter, then convert it back to a time domain using inverse fast Fourier transform to acquire new features, sequentially input the new features to a first multilayer perceptron, a deformable convolution network, and a second multilayer perceptron for processing to acquire encoder-enhanced features, and
the decoder is configured to acquire the target identification frame through depth-separable convolution.

3. The method according to claim 1, wherein acquiring the movement parameters of the apparatus by combining the three-dimensional coordinates of the key points at two consecutive moments comprises:
setting an error function et of an i^{th} key point as:
eᵢ=pᵢ−(Rp′ᵢ+T),
where pᵢ represents three-dimensional coordinates of the i^{th} key point at a current moment, p′ᵢ represents three-dimensional coordinates of the i^{th} key point at a previous moment, R represents a three-dimensional movement rotation matrix of the apparatus, and T represents a translation vector of the apparatus; and
solving for the R and T with an objective of minimizing a sum of squares of error functions of all key points.

4. The method according to claim 1, wherein combining the movement parameters to acquire the three-dimensional coordinate prediction value of the target comprises:
according to a state vector S_{k-1|k-1} of the target at a moment k−1, acquiring a prediction result S_{k|k-1} of the state vector at a moment k through a state transition matrix Φ:
S_{k|k-1}=ΦS_{k-1|k-1},
wherein the state vector is
$${S}_{k} ( {x}_{k} , {y}_{k} , {z}_{k} , {\dot{x}}_{k} , {\dot{y}}_{k} , {\dot{z}}_{k} ) , Φ = [ \begin{matrix}1 & 0 & 0 & t & 0 & 0 \\ 0 & 1 & 0 & 0 & t & 0 \\ 0 & 0 & 1 & 0 & 0 & t \\ 0 & 0 & 0 & 1 & 0 & 0 \\ 0 & 0 & 0 & 0 & 1 & 0 \\ 0 & 0 & 0 & 0 & 0 & 1\end{matrix} ] ,$$
and t represents a time interval between consecutive moments,
the three-dimensional coordinate prediction value of the target at the moment k is S_{k|k-1}=R_{k|k-1}S_{k|k-1}+T_{k|k-1}, and the movement parameters R_{k|k-1} and T_{k|k-1} are respectively a three-dimensional movement rotation matrix of the apparatus and a translation vector of the apparatus determined by combining the three-dimensional coordinates of the key points at the moments k−1 and k.

5. The method according to claim 1, wherein the three-dimensional coordinate unbiased estimation value S_{k|k} of the target is:
S_{k|k}=S′_{k|k-1}+Kₖ(Mₖ−HS′_{k|k-1}),
wherein S′_{k|k-1} is the three-dimensional coordinate prediction value, Mₖ is the three-dimensional coordinate observation value, H is an observation transformation matrix, H=
$$[ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ] ,$$
and Kₖ is a filter gain matrix, and/or
Kₖ=P′_{k|k-1}H^{T}(H P′_{k|k-1}H^{T}+Rₖ)⁻¹
P′_{k|k-1}=R_{k|k-1}P_{k|k-1}R_{k|k-1}, and
P_{k|k-1}=ΦP_{k-1|k-1}Φ^{T}+Qₖ,
where P_{k-1|k-1} is a covariance matrix at a moment k−1, Φ is a state transition matrix, Qₖ and Rₖ both represent noise, R_{k|k-1} is a three-dimensional movement rotation matrix of the apparatus determined by combining three-dimensional coordinates of key points at moments k−1 and k, P_{k|k-1} is a predicted covariance matrix at the moment k, P′_{k|k-1} is the covariance matrix at the moment k after considering the movement parameters.

6. The method according to claim 1, wherein driving the end joint of the manipulator to rotate by using the two-dimensional image of the target comprises:
inputting the two-dimensional image into a network model and outputting a rotation angle of the end joint, wherein the network model is acquired by training with a sample group composed of the determined two-dimensional image of the target and the rotation angle of the end joint, or the network model is acquired by learning a predetermined mapping relationship between the two-dimensional image of the target and the rotation angle of the end joint, and/or
the network model comprises: a convolutional neural network, a global average pooling layer, and a fully-connected layer, the convolutional neural network contains channel-by-channel convolution or point-by-point convolution to extract high-dimensional features in the two-dimensional image, the global average pooling layer is used to fuse the high-dimensional features in a spatial dimension, the fully-connected layer contains one output node for predicting the rotation angle of the end joint according to the fused high-dimensional features, and
a loss function [symbol] of the network model is:
$$ℒ = \frac{1}{N} {\sum }_{i = 1}^{N} \{ \begin{matrix}0.5 \times {( {r}_{i} - {Φ}_{r} ( {I}_{i} ) )}^{2} , & \vert {r}_{i} - {Φ}_{r} ( {I}_{i} ) \vert < 1 \\ \vert {r}_{i} - {Φ}_{r} ( {I}_{i} ) \vert - 0.5 , & other cases\end{matrix} ,$$
where N represents a number of samples, rᵢ represents an expected rotation angle, Φᵣ(Iᵢ) represents the rotation angle predicted by the network model, and Iᵢ represents the two-dimensional image.

7. A system for binocular visual servoing of an underwater vehicle-dual-arm manipulator autonomous operation, wherein an underwater vehicle and a dual-arm manipulator form an apparatus configured to perform an underwater operation, the system comprises:
an image acquisition unit configured to acquire a two-dimensional image and a depth image of a target in front of an underwater vehicle-dual-arm manipulator;
a target observation unit configured to input the two-dimensional image into a target detector to obtain a target identification frame, based on a search region of three-dimensional coordinate on the depth image, which is determined by the target identification frame, and in combination with the depth image, eliminate pixel points with invalid depth values in the search region, retain the pixel points with median depth values based on a sorting of depth values, thereby determining a three-dimensional coordinate observation value of the target;
a target prediction unit configured to determine three-dimensional coordinates of a plurality of key points on the two-dimensional image with reference to the depth image, acquire movement parameters of the apparatus by combining the three-dimensional coordinates of the key points at two consecutive moments, treat three-dimensional coordinates and a three-dimensional velocity of the target as state vectors, treat the three-dimensional coordinate observation value of the target as an observation vector, and acquire a three-dimensional coordinate prediction value of the target by combining the movement parameters;
an unbiased estimation unit configured to fuse the three-dimensional coordinate observation value and the three-dimensional coordinate prediction value based on a Kalman filtering method and obtain a three-dimensional coordinate unbiased estimation value of the target; and
a servo control unit configured to drive the apparatus to move to a predetermined position with reference to the three-dimensional coordinate unbiased estimation value of the target, control an effector of at least one manipulator to move toward the target according to the three-dimensional coordinate unbiased estimation value of the target, and drive an end joint of a corresponding effector to rotate by using the two-dimensional image of the target, so that after the at least one manipulator reaches the target, the effector thereof effectively clamps the target,
wherein determining the three-dimensional coordinate observation value of the target comprises:
treating a center point within the target identification frame as a center of the search region on the depth image and determining a width and a height of the search region according to a size of the target identification frame;
matching the depth image with the two-dimensional image according to pixel coordinates and acquiring the depth value of each pixel point within the search region;
sorting all pixel points within the search region according to the depth values;
eliminating invalid pixel points in the search region based on a predetermined sorting threshold and acquiring a new pixel point set;
keeping middle pixel points by order in the new pixel point set; and
averaging three-dimensional coordinates of all retained pixel points and obtaining the three-dimensional coordinate observation value of the target,
wherein retaining the pixel points with the median depth values in the new pixel point set comprises:
calculating an upper quartile Q₁ and a lower quartile Q₂ of a sorting in the new pixel point set:
$${Q}_{1} = \frac{n + 1}{4} , {Q}_{2} = \frac{3 ( n + 1 )}{4} ,$$
wherein, n is a total number of pixel points comprised in the new pixel point set;
treating depth values at positions corresponding to Q₁ and Q₂ as thresholds ε₁ and ε₂ if Q₁ and Q₂ are integers;
performing rounding up and rounding down if Q₁ and Q₂ are not integers, obtaining Q^{up}₁, Q^{down}₁, Q^{up}₂, and Q^{down}₂, and obtaining four depth values ε^{up}₁, ε^{down}₁, ε^{up}₂, and ε^{down}₂ at corresponding positions, ε₁=0.25×ε^{up}₁+0.75×ε^{down}₁ and ε₂=0.75×ε^{up}₂+0.25×ε^{down}₂; and
retaining pixel points when a depth value pᵢ satisfies ε₁<pᵢ<ε₂.

8. An electronic apparatus, comprising:
at least one memory configured to store a computer program; and
at least one processor configured to execute the program stored by the memory and execute the method according to claim 1 when the program stored by the memory is executed.
